(19) United States
(12) Patent Application Publication
(10) Pub. No.: US 2019/0284424 A1
(43) Pub. Date: Sep. 19, 2019

(54) Methods For Making And Enhancing Properties Of Polymer Composite Materials Used In Fused Filament Fabrication

(71) Applicant: The University of Tulsa, Tulsa, OK (US)

(72) Inventors: Gabriel LeBlanc, Tulsa, OK (US); Marjorie Sheaff, Owasso, OK (US); Heather Whitehead, Bartlesville, OK (US); Julia Waldman, Bixby, OK (US)

(21) Appl. No.: 16/356,428

(22) Filed: Mar. 18, 2019

Related U.S. Application Data
(60) Provisional application No. 62/644,314, filed on Mar. 16, 2018.

(51) Int. Cl. C09D 11/52; C09D 11/037; C09D 11/033; C09D 11/104; C09D 11/106; B33Y 70/00

(52) U.S. Cl. CPC C09D 11/52; C09D 11/037; B33Y 70/00; C09D 11/104; C09D 11/106; C09D 11/033

(57) ABSTRACT

3D printing is an increasingly popular production method to quickly and inexpensively produce specialized components. Designs can be easily shared online and customized to the needs of the end user. One exciting aspect of 3D printing is the potential for printing with electrically conductive materials. Conductive filaments for fused filament fabrication are typically a mixture of polymer and conductive carbon powder. Printing with these should allow for development of unique electrochemical devices. However, commercial conductive filaments are difficult to print with and are not conductive enough for some electrochemical applications. Here we present several post print procedures to increase the conductivity of these filaments. By using and understanding how these strategies enhance the conductivity, the possibilities for performing complicated electrochemical experiments increases, opening up new paths of discovery in electrochemistry and material science.

### CROSS REFERENCE TO RELATED APPLICATION

This application claims the benefit of U.S. Provisional Application No. 62/644,314 filed Mar. 16, 2018, herein incorporated by reference in its entirety for all purposes

### FIELD OF THE INVENTION

This invention relates to the field of three dimensional (3D) printing, generally, and more specifically to 3D printing by fused filament fabrication.

### BACKGROUND OF THE INVENTION

3D printing has recently provided a plethora of new concepts in the chemical sciences due to the ability to generate unique geometries on demand for highly specific experiments at low cost. One of the most widely available 3D printing technologies is fused filament fabrication (FFF), also known as fused deposition modeling (FDM). This method uses a thermoplastic filament fed through a hot end that is moved in the x, y, and z axes. By applying this filament in specific locations, a wide variety of shapes can be generated, including some that are not possible with traditional subtractive manufacturing techniques. While other 3D printing methods can be used to generate conductive materials, FFF is one of the most common methods for 3D printing and can allow for multiple materials (filaments) to be used on the same structure (object). The properties of the 3D printed component using the FFF method are dictated by both the design of the object and the thermoplastic used as the filament. While polylactic acid (PLA) and acrylonitrile butadience styrene (ABS) are the most common filaments used in FFF, commercial suppliers sell a wide variety of thermoplastics and thermoplastic composite materials that have different physical properties and chemical compatibilities.

The development and use of thermoplastic composites provides opportunities to incorporate new functionality and properties into 3D printed materials. Of particular interest to the field of electrochemistry is the ability to print with conductive filaments. Conductive filaments are typically composed of PLA or ABS along with a conductive carbon material such as carbon black, carbon nanotubes, or graphene. Other conductive additives such as copper powder or silver ink have also been developed with reported resistivity as low as 0.006 Ωcm, but are much more challenging to print with using a traditional FFF 3D printer. The resistivity of carbon based conductive filaments can range from 1000-0.6 Ωcm, where decreasing resistivity results in increased prices and in difficulty to print. The difficulty in printing primarily stems from the relatively high ratio of conductive material to thermoplastic. These higher ratios result in a more brittle filament material as well as leading to the clogging of the printer nozzle.

For all of these conductive filaments, however, the printed material cannot be used as an effective electrode in many traditional electrochemical experiments due to their high impedance. This has precluded the use of FFF 3D printed electrodes from playing a significant role in electroanalytical experiments, while the use of 3D printed devices has recently been shown to be valuable in a wide range of other analytical techniques. A need, therefore, exists for a method to increase the impedance (conductivity) of conductive filaments without decreasing resistivity of the filament during 3D printing.

### SUMMARY OF THE INVENTION

The present invention includes methods of employing a chemical reaction for the removal of one (or more) polymer(s) of a polymer composite material to improve one, or more, physical properties of the composite as well as the resulting composition. Moreover, the present invention relates to the enhancement and/or increase of the relative concentration of one component of a composite material by removing a relative concentration of another component of the composite material so as to enhance one or more physical properties of the resulting composition. Representative contemplated physical properties include, but are not limited to, conductivity, elasticity, porosity, and strength density (strength to weight).

3D printing is an increasingly popular production method to quickly and inexpensively produce specialized components. Designs can be easily shared online and customized to the needs of the end user. One aspect of 3D printing is the potential for printing with electrically conductive materials. Conductive filaments for fused filament fabrication are typically a mixture of polymer and conductive carbon powder. Printing with these should allow for development of unique electrochemical devices. However, commercial conductive filaments are difficult to print with and are not conductive enough for some electrochemical applications.

In the present disclosure, several post print procedures are presented to increase a physical property (the conductivity) of these conductive filaments. By using and understanding how these strategies enhance the physical property, the possibilities for performing complicated electrochemical experiments increases, opening up new paths of discovery in electrochemistry and material science.

This disclosure includes a general strategy for improving the material properties of a FFF 3D printed part through the selective removal of the thermoplastic to increase the relative ratio of the active component in the finished part. This differs from previous methods where the degradation of the thermoplastic is used to release an active material into the environment (such as the aqueous degradation of a polyvinyl alcohol composite to release pharmaceuticals). We have demonstrated this using conductive composite materials by selectively removing select portions of the thermoplastic material to increase the relative concentration of the conductive carbon material. Two main strategies are presented based on the removal of different types of common thermoplastics. The first is the use of hydroxide solutions to selectively degrade polymer based components of a composite material (such as poly lactic acid (PLA) based composites). The second is the use of electrolysis treatment for the selective removal of polymer based components of a composite material (such as poly vinyl alcohol (PVA) based composites). A third strategy could be the use of ultraviolet (UV) light to selectively degrade Acrylonitrile butadiene styrene (ABS) based composites. These strategies significantly reduce the resistance of the printed material, in some cases enough to enable electrochemical measurements comparable to traditional carbon based electrodes. Building from this concept, the present disclosure further relates to the formation of a new composite consisting of an easily degraded thermoplastic for better controlled and easier performance enhancement based on this strategy.

Examples of commercially available conductive filaments intended for FFF 3D printing include Proto-Pasta, available from ProtoPlant (https://www.proto-pasta.com/pages/conductive-pla#CCmade); Black Magic 3D (http://www.blackmagic3d.com/Conductive-p/grphn-pla.htm); Gizmodorks (http://gizmodorks.com/abs-3d-printer-filament); Multi3D, L.L.C. (http://gizmodorks.com/abs-3d-printer-filament/), and; Functionalize, Inc. (http://functionalize.com/about/functionalize-f-electric-highly-conductive-filament/). It should be understood that these are non-limiting examples.

Immediate applications are in the area of 3D printing filament design/development. Contemplated future applications include the generation of 3D printed electronics, batteries, photovoltaics, sensors, etc.

The processed material has superior conductivity properties than present technology. The PVA blended composites (method 3 below) would further enhance process ability (make the filament easier to 3D print with).

The present disclosure includes an improved conducive composition resulting from fused filament fabrication 3D printing using a conductive filament including at least a weight % of conductive material, and a weight % of polymer dissolvable in a solvent. The conductive composition includes an increased weight % of conductive material and a reduced weight % of polymer as a result of soaking the composition in the solvent. The conductive material may be carbon black. The polymer may be a poly lactic acid based composite and the solvent a hydroxide solution such as sodium hydroxide.

In an alternate embodiment, the polymer may be an acrylonitrile butadiene styrene (ABS) based composite and the solvent UV light.

In another alternate embodiment, the polymer may be a poly-vinyl alcohol composite and the solvent water.

Another aspect of the present disclosure includes a filament composition for use in fused filament fabrication 3D printing including a conductive material; a first thermoplastic wherein the first thermoplastic is dissolvable in a first solvent; and a second thermoplastic wherein the second thermoplastic is not dissolvable in the first solvent.

In one embodiment the solvent may be water; the first thermoplastic poly-vinyl alcohol; the second solvent poly lactic acid, and; the conductive material carbon black.

The present disclosure also includes a method for improving a physical property of a composition produced by fused filament fabrication 3D printing using a filament including a base material and a polymer. The method includes subjecting the composition to a solvent in conditions sufficient to degrade the polymer and thereby enhancing the physical properties of the base material. A more specific embodiment includes a method for improving the conductivity of a composition produced by fused filament fabrication 3D printing using a filament including a weight % of a first conductive material and a weight % of a first polymer, and the method includes subjecting the composition to a solvent in conditions sufficient to degrade a weight % of the first polymer and thereby enhancing the weight % of the fist conductive material.

An alternate method for improving the conductivity of a composition includes obtaining a filament including a conductive material and a first polymer wherein the first polymer is degradable by a first solvent; printing the composition by fused filament fabrication 3D printing using the filament; obtaining a first solvent and; subjecting the printed composition to the first solvent in conditions sufficient to degrade the first polymer. The filament may include a second polymer wherein the second polymer is not degradable by the first solvent.

This method may also include subjecting the printed composition to the first solvent by soaking the printed composition in the first solvent in conditions sufficient to dissolve at least some of the first polymer. Alternately, the first polymer may be an acrylonitrile butadiene styrene composite and the first solvent UV light such that said method further includes exposing the printed composition to the UV light in conditions sufficient to degrade at least some of the first polymer.

The present disclosure includes a method for improving the physical properties of a composition, and a composition printed by fused filament fabrication 3D printing methods. As used herein, the term solvent is used in a general sense for any actor, the exposure to which affects (degrades, dissolves, etc.) a physical property of one component (i.e., weight % of polymer) thereby enhancing another physical property (weight % an thereby conductivity of a conductor).

It is contemplated that improving other physical properties of a composition, in addition to conductivity, can be accomplished as a result of the method of the present disclosure.

The foregoing has outlined in broad terms the more important features of the invention disclosed herein so that the detailed description that follows may be more clearly understood, and so that the contribution of the instant inventors to the art may be better appreciated. The instant invention is not limited in its application to the details of the construction and to the arrangements of the components set forth in the following description or illustrated in the drawings. Rather the invention is capable of other embodiments and of being practiced and carried out in various other ways not specifically enumerated herein. Additionally, the disclosure that follows is intended to apply to all alternatives, modifications and equivalents as may be included within the spirit and the scope of the invention as defined by the appended claims. Further, it should be understood that the phraseology and terminology employed herein are for the purpose of description and should not be regarded as limiting, unless the specification specifically so limits the invention.

### BRIEF DESCRIPTION OF THE DRAWINGS

FIG. 1 illustrates the effect of hydroxide soaking on the performance of an electrically conductive 3D printed filament. A) Resistance of a 3D printed electrode as a function of soaking time in a hydroxide solution. B) Cyclic voltammetry of a ferrocyanide.

FIG. 2 illustrates the effect of hydroxide soaking on the impedance of an electrically conductive 3D printed filament wherein two different commercially available filaments were evaluated.

FIG. 3 demonstrates the presence of lactic acid in the soaking solution as evidenced by spectroscopic signals. 3A) Fourier-transform infrared (FTIR) spectra of the NaOH solution (black), lactic acid spiked into the NaOH solution (green), and the NaOH solution after a printed electrode was soaked for 24 hours (blue). Note that all samples were concentrated to dryness to enhance the signal. 3B) Nuclear magnetic resonance (NMR) spectrum of the NaOH solution after a printed electrode was soaked for 24 hours. The observed peaks are indicative of lactic acid.

FIG. 4 illustrates mass loss effects caused by hydroxide soaking. 4A) The mass of electrode samples as a function of hydroxide soak time. Two different commercial filaments (blue and orange) were tested, showing different rates of mass loss, likely due to differences in the thermoplastic blend used in the composite. 4B) Thermogravimetric analysis of printed conductive filament before (black) and after 6 hour hydroxide treatment (blue). The higher mass at 450° C. indicates a higher conductive carbon ratio. 4C) FIG. 4B including the NMR spectrum of the non-conductive control sample.

FIG. 5 demonstrates the effect of UV exposure on the resistance of a conductive ABS filament.

FIG. 6 demonstrates the effect of electrolysis treatment on 3DEs. 6A) Bode plot of ProtoPasta (PP) and BlackMagic (BM) electrodes before and after 24 hour electrolysis treatment in a 1M KCl electrolyte. Inset is a photograph of the 3D printed divided electrolysis cell system. The color in the cell comes from universal indicator that was added to demonstrate the effectiveness of the cell. 6B) CV of untreated (lighter curves) and electrolysis treated (darker curves) FFF 3DEs prepared from ProtoPasta conductive filament (left, red) and BlackMagic conductive filament (right, black). CV performed in an electrolyte consisting of 10 mM ferricyanide and 1M KCl at a scan rate of 10 mV/s

FIG. 7 demonstrates the results of . spectroelectrochemical experiments performed using a 3D printed electrochemical cell. 7A) Spectroelectrochemical experiments using an untreated 3DE printed as part of a larger electrochemical cell in an electrolyte consisting of universal indicator and 1M KCl with application of a 9V battery beginning at 30 s. The solid line represents the connection of the 3DE to the cathode while the dashed line represents the connection to the anode. Inset is a photograph of a cell printed using natural PLA for contrast (experiments performed on cells using black PLA to minimize light scatter). 7B) Spectroelectrochemistry in an electrolyte consisting of 10 mM ferricyanide and 1M KCl at a scan rate of 1 mV/s using a hydrolysis treated 3DE.

### DETAILED DESCRIPTION OF THE PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processes and manufacturing techniques are omitted so as to not unnecessarily obscure the embodiments herein. The examples used herein are intended merely to facilitate an understanding of ways in which the invention herein may be practiced and to further enable those of skill in the art to practice the embodiments herein. Accordingly, the examples should not be construed as limiting the scope of the claimed invention.

The present disclosure describes a benign activation method for the FFF 3DEs based on the saponification of polylactic acid (PLA) insulating material using hydroxide. This method uses readily available materials and can even be applied using the electrolysis of water to prevent the generation of hazardous waste. We describe the mechanism behind the performance enhancement and detail how different PLA materials can be used in tandem with these conductive filaments to enable spectroelectrochemical experiments.

Method 1: Hydroxide Soaking of PLA Based Filaments

PLA is susceptible to saponification, as seen in the representative mechanism of the saponification process for a trimeric polylactic acid polymer to produce lactate monomers, set forth below. In this process, the hydroxide serve as nucleophile and attacks the electrophilic carbonyl present in the ester. The process repeats to break the PLA into smaller polymer chains and ultimately into lactate.

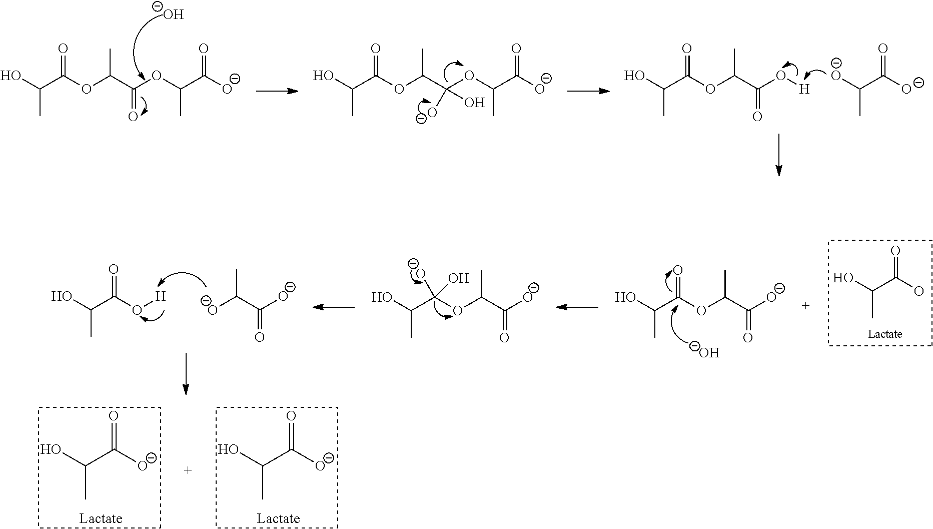

The use of alkaline solutions to improve the performance of FFF 3DEs has shown to be effective. As an aliphatic polyester, PLA is susceptible to saponification. Printed electrodes were soaked in a strong hydroxide (4M NaOH) solution and evaluated using a variety of methods. Electrochemical performance of hydroxide soaked electrodes was found to be superior to dimethylformamide (DMF) activation, likely due to the difference in the PLA removal mechanism. This was further confirmed using four point probe conductivity measurements. Spectroscopic analysis of the electrodes and the hydroxide soaking solution confirmed that the saponification process is taking place rather than the removal of the PLA through as physical process as is the case in DMF activation. Evaluation of the hydroxide activation on different vendors of PLA composite filaments found that the more conductive BlackMagic filament undergoes a much more rapid decrease in mass and resistance than the less expensive ProtoPasta, which uses carbon black rather than graphene as the added conductive material. This is likely due to a second polymer present in the ProtoPasta, likely an elastomer, which may slow down the saponification process. This second polymer, also provides additional structural support following exposure to the hydroxide activation process.

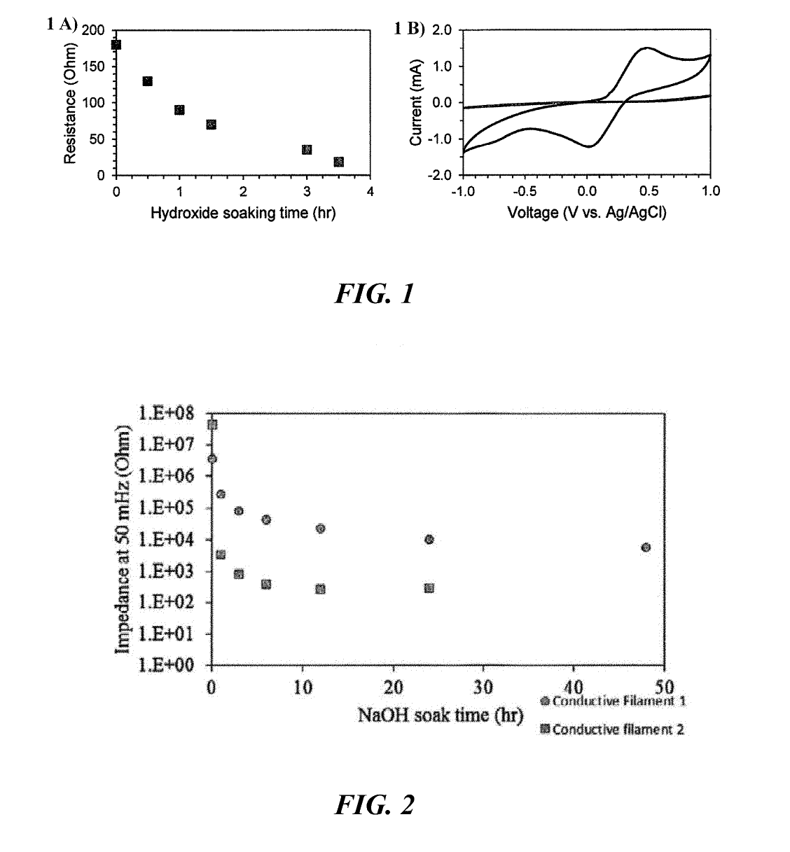

In this method, the PLA/carbon composite filament is soaked in a hydroxide solution (0.5-4 M) either before or after 3D printing. As seen in FIG. 1, the resistance of the filament decreases by a factor of 10 after 3.5 hours. This increase in conductivity dramatically increases the ability to observe electrochemical activity.

Electrochemical impedance spectroscopy (EIS) has been used to further demonstrate this improvement for electrochemical applications. As seen in FIG. 2, the impedance of two different commercial filaments was decreased by several orders of magnitude. FIG. 2 illustrates the effect of hydroxide soaking on the impedance of an electrically conductive 3D printed filament wherein two different commercially available filaments were evaluated.

Electrochemical analysis was performed on these electrodes activated in hydroxide solutions to evaluate the efficacy of this treatment process. EIS was used as a general method for evaluating how the resistance of the electrode changed as a function of hydroxide soaking. For both composite materials, the resistance of the electrode decreased by three orders of magnitude as the PLA was removed. The importance of this resistance decrease can be observed in the CV of ferricyanide, a common redox couple. While electrodes printed using filaments from both manufacturers undergo significant improvement after a 24 hour hydroxide soaking process, the peak separation is much smaller for treated electrodes prepared from BlackMagic filament. This is expected based on the significantly lower resistance values for these electrodes. However, the improvement in electrochemical performance of the ProtoPasta filament, which is significantly less expensive than the BlackMagic filament, is noteworthy. Not only is the current significantly enhanced, but distinct redox peaks were observed. Coupled with the additional structural support from the second polymer in the ProtoPasta electrodes, this may justify using this, or similar, less conductive filament in electrochemical applications.

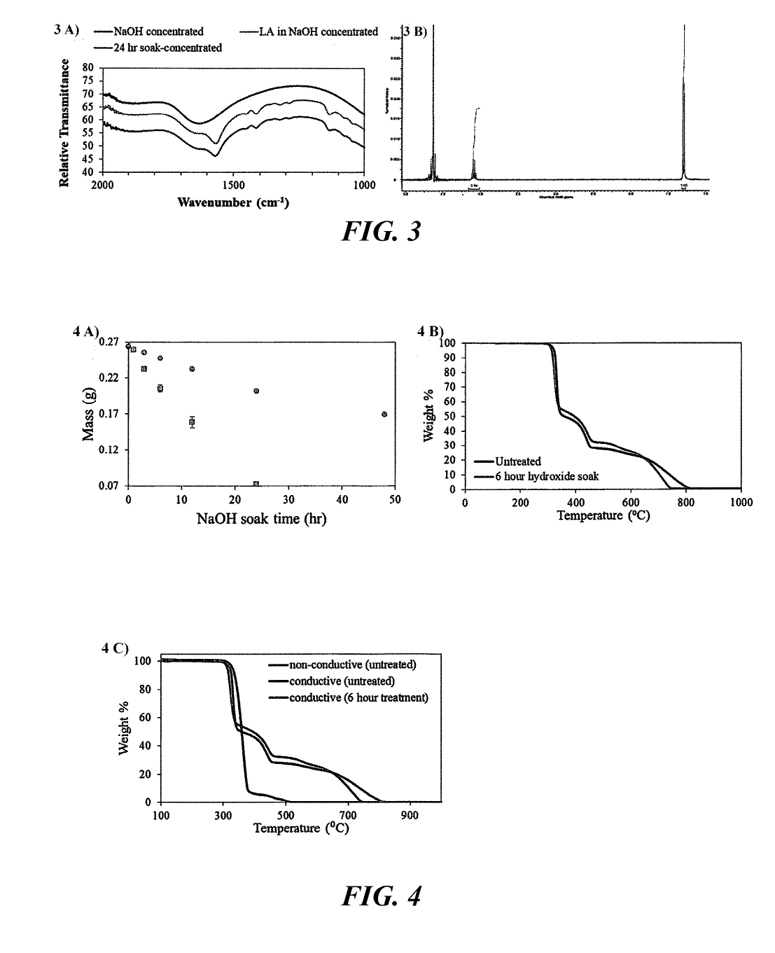

Preliminary experiments demonstrate that this increase in conductivity can be attributed to the degradation of the PLA polymer via a base hydrolysis reaction of the esters present in the PLA polymer. This depolymerization process is evidenced by the presence of lactic acid (the monomer from the polymer) in the hydroxide solution as observed in the data presented in FIG. 3.

FIG. 3 depicts the presence of lactic acid in the soaking solution as evidenced by spectroscopic signals. FIG. 3A) depicts the Fourier-transform infrared (FTIR) spectra of the NaOH solution (top), lactic acid spiked into the NaOH solution (middle), and the NaOH solution after a printed electrode was soaked for 24 hours (bottom). Note that all samples were concentrated to dryness to enhance the signal. FIG. 3B) shows the Nuclear magnetic resonance (NMR) spectrum of the NaOH solution after a printed electrode was soaked for 24 hours. The observed peaks are indicative of lactic acid. Note that the sample was first neutralized and then concentrated to enable the NMR measurement. FIG. 4C) is FIG. 4B including the NMR spectrum of the non-conductive control sample.

The enhancement in the conductive properties is attributed to an increase in the conductive carbon to thermoplastic ratio. From gravimetric analysis (FIG. 4A), it is clear that the 3D printed component loses mass as a function of hydroxide soaking time. We note that no mass loss is observed to components soaked in neutral water solutions. Thermogravimetric data (FIG. 4B) demonstrates the increase in conductive carbon as the remaining % weight of the sample at 450° C. is higher after hydroxide soaking. We note that control samples (without conductive carbon) had a remaining % weight of approximately 4% at 450° C. The non-conductive filament has approximately 4% weight percent remaining at 450 C, the conductive filament (untreated) has approximately 30% remaining at 450 C, and the treated filament has approximately 35% remaining at 450 C (FIG. 4C). This suggests that the conductive carbon content in the treated sample is approximately 5% higher than in the untreated sample.

FIG. 4 depicts the Mass loss effects caused by hydroxide soaking. FIG. 4A) shows the mass of electrode samples as a function of hydroxide soak time. Two different commercial filaments were tested, showing different rates of mass loss, likely due to differences in the thermoplastic blend used in the composite. FIG. 4B) shows the thermogravimetric analysis of printed conductive filament before and after 6 hour hydroxide treatment. Note, the higher mass at 450° C. indicates a higher conductive carbon ratio.

The hydroxide soaking process clearly results in the loss of the peak at 5.17 ppm and the reduction of the peak at 1.58 ppm, which can be directly attributed to PLA. The soaking solution from this process subsequently shows the appearance of peaks associated with lactate. Taken in combination, this information confirms that the saponification reaction process is followed for these conductive composite filaments.

The mass of the electrodes decreased significantly after soaking in these solutions. The rate of this mass loss was dependent on the vendor of the composite filament, with the more conductive BlackMagic filament undergoing a much more rapid decrease in mass than the less expensive ProtoPasta, which uses carbon black rather than graphene as the added conductive material. Analysis by thermogravimetric analysis suggests that this is likely due to a second polymer present in the ProtoPasta that may slow down the saponification process. This second polymer, likely an elastomer, also provides additional structural support in the treated sample, as evidenced by the limited size reduction relative to the electrodes prepared using BlackMagic filament. Soaking BlackMagic electrodes longer than 24 hours in 4M NaOH resulted in samples that were difficult to handle without breaking; however, ProtoPasta samples could be soaked indefinitely and became more flexible when soaked for long periods of time.

Method 2: Electrolysis Treatment

The use of hydroxide solutions rather than organic solvents makes the activation of FFF 3DEs more accessible due to the low cost and availability of NaOH. However, the need to prepare, store, and dispose of chemical waste may still present a significant barrier in the application of this strategy.

As one alternative embodiment of the present disclosure, chemical preparation is not the only means of generating a strong alkaline solution. The electrolysis process proceeds through the reduction of water (or excess hydrogen cations) at the cathode to generate hydrogen gas and the oxidation of water (or excess hydroxide anions) at the anode to generate oxygen gas. Less obvious is the dramatic change in pH that occurs at each electrode. To demonstrate this phenomenon, we have added universal indicator to a 1M KCl electrolyte solution and used a 9V battery to cause the electrolysis of water using FFF 3DEs in a separated electrochemical cell. The pH of the electrolyte around the cathode quickly increases while the pH of the electrolyte around the anode decreases. Using a pH meter, the electrolyte in the cathode compartment was measured to be 12.4±0.1 and the anode compartment was measured to be 1.2±0.1. At the conclusion of the electrolysis process the two electrolysis compartments can be mixed to partially neutralize the solutions. Therefore, the hydroxide soaking process can be applied to a FFF 3DE using electrochemistry, with the waste solution safe enough to pour down the sink or potentially reuse.

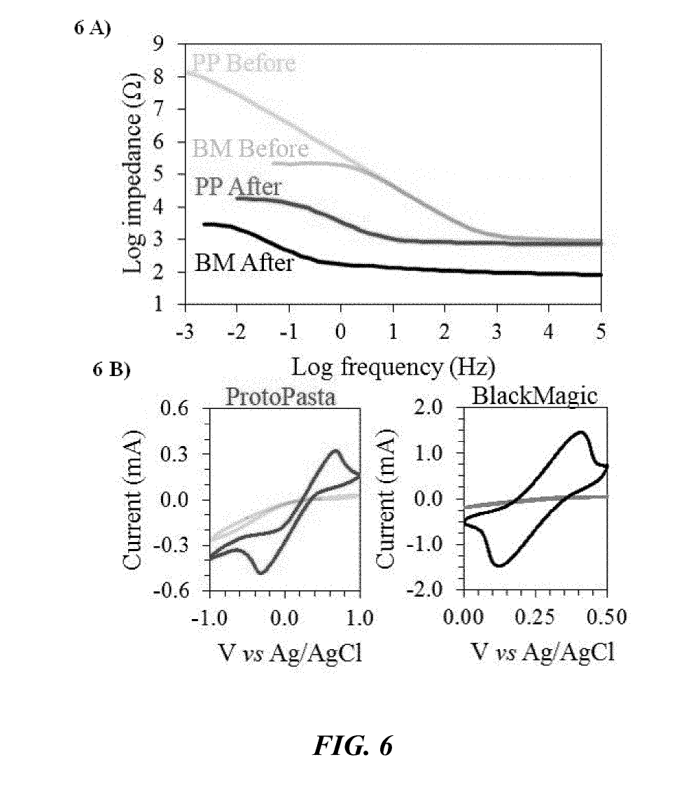

To demonstrate that electrolysis treatment is effective as an activation process for 3DEs, a divided 3D printed electrolysis cell was developed and a 24 hour electrolysis treatment was performed on both filament types. The electrolysis cell was printed using ABS, which is not sensitive to the drastic pH changes that occur during the electrolysis experiment. Additionally, the two compartments of the electrolysis cell are connected by a simple salt bridge made by soaking a paper towel in the 1M KCl electrolyte. The 3DEs were designed in such a way that the entire electrode to be analyzed afterwards would be in contact with the electrolysis solution, while the connection to the 9V battery could be easily removed after electrolysis if desired. After 24 hours, the impedance of the treated electrodes is reduced in a similar fashion to the soaking process, as observed in the Bode and cyclic voltammetry (CV) plots (FIG. 6).

While a 9V battery is easily accessible and modified with alligator clips to perform the electrolysis treatment of FFF 3D printed electrodes, the voltage required to perform this process is significantly less. CVs of the as-printed electrodes were used to demonstrate that the electrolysis process begins at approximately −2V vs Ag/AgCl for the ProtoPasta filament and approximately −1.5V vs Ag/AgCl for the BlackMagic filament. For applications of these 3DEs in electrochemical systems, the use of a potentiostat may offer a more cost sustainable strategy than the use of non-rechargeable 9V batteries if the equipment is readily available, though the use of 9V batteries can enable a significant number of electrodes to be activated simultaneously.

FIG. 6 depicts the effect of electrolysis treatment on 3DEs. FIG. 6A) depicts a Bode plot of ProtoPasta (PP) and BlackMagic (BM) electrodes before and after 24 hour electrolysis treatment in a 1M KCl electrolyte. Inset is a photograph of the 3D printed divided electrolysis cell system. FIG. 6B) is the CV of untreated (lighter curves) and electrolysis treated (darker curves) FFF 3DEs prepared from ProtoPasta conductive filament (left) and BlackMagic conductive filament (right). CV performed in an electrolyte consisting of 10 mM ferricyanide and 1M KCl at a scan rate of 10 mV/s.

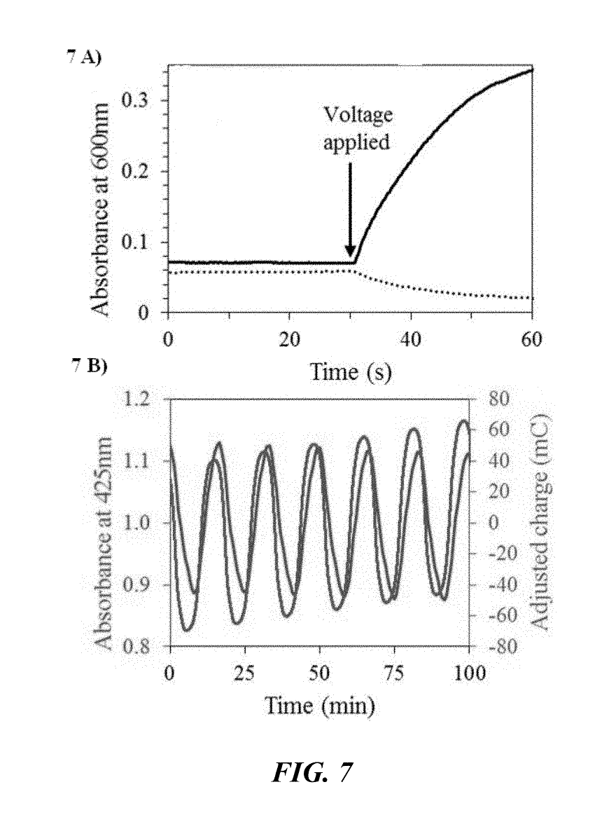

The utility of these 3DEs was demonstrated using a 3D printed spectroelectrochemical system (FIG. 7). This illustrates the unique advantages of FFF 3D printing, where multiple material types can be simultaneously incorporated into a single design with patterns that would be complex to manufacture using traditional manufacturing technologies. By using a PLA based conductive composite, material adhesion with non-conductive PLA filament is enhanced. Leveraging the different saponification kinetics observed with different PLA filament manufacturers, we are able to perform the hydroxide treatment (via hydrolysis) without compromising the integrity of the overall spectroelectrochemical cell. Performing spectroelectrochemical experiments in an electrolyte containing universal indicator (FIG. 7A) allows for the observation of pH changes of the electrochemical cell during the hydrolysis treatment process. Note that the absorbance at 600 nm increases under alkaline conditions and decreases under acidic conditions relative to neutral conditions. From these experiments, it is clear that the hydrolysis process begins immediately following application of sufficient voltage. Experiments performed in an electrolyte containing ferricyanide (FIG. 7B) show the expected changes in absorbance as a function of oxidation state during a CV experiment. These experiments demonstrate the versatility and utility of these 3DE systems. Furthermore, the integration of these 3DEs into a larger 3D printed device illustrates the value of a hydroxide treatment strategy that is benign compared with other organic solvent treatment systems that would damage the non-electrode components present in the device.

FIG. 7 depicts the spectroelectrochemical experiments perform using a 3D printed electrochemical cell. FIG. 7A) depicts pectroelectrochemical experiments using an untreated 3DE printed as part of a larger electrochemical cell in an electrolyte consisting of universal indicator and 1M KCl with application of a 9V battery beginning at 30 s. The solid line represents the connection of the 3DE to the cathode while the dashed line represents the connection to the anode. Inset is a photograph of a cell printed using natural PLA for contrast (experiments performed on cells using black PLA to minimize light scatter). FIG. 7B) shows spectroelectrochemistry in an electrolyte consisting of 10 mM ferricyanide and 1M KCl at a scan rate of 1 mV/s using a hydrolysis treated 3DE.

FFF can be used to generate custom electrodes with commercial carbon-based filaments, however the presence of insulating PLA significantly hinders the conductivity of the printed electrodes. The present disclosure demonstrates that saponification of the PLA can be used to decrease the resistance of these printed electrodes by three orders of magnitude. This saponification process can be applied through either a hydroxide soaking process or through the use of water electrolysis with near equal efficacy. The use of electrolysis significantly improves the accessibility of this electrode activation process while minimizing exposure to hazardous or caustic solutions. We believe that this will make the use of 3DEs easier to adopt for a wide variety of unique applications.

A 3D printed spectroelectrochemical cell complete with a honeycomb electrode was printed using a dual extrusion FFF printer, activated using hydrolysis, and tested using two different electrolyte solutions to demonstrate the advantages of using these materials with a hydroxide activation process. By providing an accessible means for creating electrochemically active 3DEs, we believe that new electrochemical applications can be explored. More broadly, the concept of activating 3D printed composite systems using electrochemical treatment offers a unique strategy to alter the properties of 3D printed materials post-printing

Method 3: UV-Exposure of ABS Based Filaments

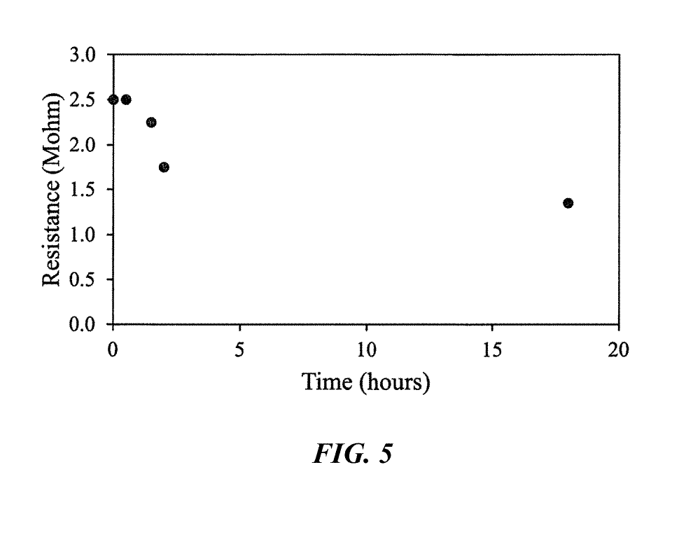

FIG. 5 depicts the effect of ultraviolet (UV) exposure on the resistance of a conductive ABS filament. ABS/carbon composite filaments are not compatible with method 1 due to the chemical resistance of ABS to base hydrolysis processes. However, ABS is known to degrade under exposure to UV light. Here we demonstrate how exposure to UV light results in a 40% decrease in resistivity. The combination of method 1 and 2 demonstrate the general concept of improving the physical properties of a 3D printed part (a composition) through selective degradation of the thermoplastic.

Method 4: PVA Blended Composites for Enhanced Process Ability

Due to the corrosive nature of hydroxide solution and the inherent dangers of using UV light, we claim the production of a new blended conductive composite filament that includes significant concentrations of polyvinyl alcohol (PVA), a water soluble thermoplastic commonly used in 3D printing. In doing so, the post-processing method for enhancing the conductivity of 3D printed composites becomes more straightforward and safer: the printed part is simply soaked in water to remove the PVA. The overall composite includes PVA, a second thermoplastic (i.e. PLA), and conductive material (i.e. carbon black). The combination of these materials ensured structural integrity from the second thermoplastic, conductivity from the conductive material, and process ability from the PVA.

Materials, Instruments, and Procedures

Materials. Sodium hydroxide, potassium ferricyanide, and potassium chloride were purchased from Fisher Chemical. pH test universal indicator solution was purchased from General Hydroponics and used at a 1:50 dilution with 1M KCl electrolyte. Natural PLA and ABS filaments were purchased from MatterHackers. Conductive PLA composite filaments were purchased from ProtoPasta and BlackMagic3D.

3D printing. All 3D printed objects were designed with SketchUp Make 2017 available free from Google (http://www.sketchup.com/). All CAD and .stl files described in this work are freely available under a creative commons license (https://www.thingiverse.com/LeBlanc-Research-Group/designs). Designs were sliced using Cura for Lulzbot (https://www.lulzbot.com/cura), a free software that is based off of the more universal Cura software from Ultimaker (https://ultimaker.com/en/products/cura-software). Objects were printed using with a LulzBot Mini or LulzBot Taz 6 FFF printer. Note that the Taz 6 printer was equipped with a v3 dual extruder tool head and used to print the spectroelectrochemical cells in a single print. PLA based filaments were printed at 220° C. onto a print bed heated to 60° C. using 0.1 mm layer heights and 100% infill. Parts in ABS (namely electrolysis cells and the electrochemical cells) were printed at 240° C. onto a print bed heated to 115° C. using 0.3 mm layer heights and 100% infill. Several designs were used for the experiments described in the present disclosure. The CAD and .stl files for these designs can be found in Thingiverse (https://www.thingiverse.com/LeBlanc-Research-Group/designs) incorporated fully herein by reference.

Electrochemistry. All electrochemical experiments, with the exception of most hydrolysis experiments, were performed using a Biologic SAS SP-300 potentiostat. A Ag/AgCl and platinum wire were used as the reference and counter electrodes, respectively. A 3D printed electrochemical cell and cap were used for electrochemical experiments. Additional information regarding the parameters for electrochemical impedance spectroscopy can be found in the supporting information. An electrolyte volume of 10 mL was used for voltammetry and impedance experiments. Electrolysis experiments were performed in a 3D printed divided electrochemical cell with 15 mL of electrolyte. Electrochemical connection between the compartments was maintained by using an approximately 1 cm² section of paper towel dipped in the electrolyte of both compartments. Unless otherwise stated, electrolysis was performed using a 9V battery. Connection from the battery to the electrodes was accomplished using commercial 9V battery snap connectors with alligator clips. Note that the negative terminal (typically the black wire) will connect to the compartment that becomes more alkaline.

Conductivity and Spectroscopy. Conductivity was measured using a Van Der Pauw controller (MMR Technologies, CA). UV-vis spectra were collected using a Shimadzu UV-1800 UV-vis spectrometer using a 3D printed cuvette adapter based on a previously published design from our group

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The term “at least” followed by a number is used herein to denote the start of a range beginning with that number (which may be a ranger having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. Terms of approximation (e.g., “about”, “substantially”, “approximately”, etc.) should be interpreted according to their ordinary and customary meanings as used in the associated art unless indicated otherwise. Absent a specific definition and absent ordinary and customary usage in the associated art, such terms should be interpreted to be ±10% of the base value.

When, in this document, a range is given as “(a first number) to (a second number)” or “(a first number)-(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Thus, the present invention is well adapted to carry out the objects and attain the ends and advantages mentioned above as well as those inherent therein. While presently preferred embodiments have been described for purposes of this disclosure, numerous changes and modifications will be apparent to those skilled in the art. Such changes and modifications are encompassed within the spirit of this invention as defined by the appended claims.

What is claimed is:

1. An improved conducive composition resulting from fused filament fabrication 3D printing using a conductive filament including at least a weight % of conductive material, and a weight % of polymer dissolvable in a solvent wherein the conductive composition is soaked in the solvent, said conductive composition comprising:
an increased weight % of said conductive material, and;
a reduced weight % of said polymer as a result of soaking the composition in the solvent.

2. The conductive composition of claim 1 wherein the conductive material is carbon black.

3. The conductive composition of claim 1 wherein said polymer is a poly lactic acid based composite.

4. The conductive composition of claim 3 wherein said solvent is a hydroxide solution.

5. The conductive composition of claim 4 wherein said solvent is sodium hydroxide.

6. The conductive composition of claim 1 wherein said polymer is an acrylonitrile butadiene styrene based composite.

7. The conductive composition of claim 3 wherein said composition is subject to electrolysis treatment.

8. The conductive composition of claim 1 wherein said polymer is a poly-vinyl alcohol composite.

9. The conductive composition of claim 8 wherein said solvent is water.

10. A filament composition for use in fused filament fabrication 3D printing comprising:
a conductive material;
a first thermoplastic wherein said first thermoplastic is dissolvable in a first solvent;
a second thermoplastic wherein said second thermoplastic is not dissolvable in said first solvent.

11. The filament of claim 10 wherein said first solvent is water.

12. The filament of claim 11 wherein said first thermoplastic is poly-vinyl alcohol.

13. The filament of claim 12 wherein said second solvent is poly lactic acid.

14. The filament of claim 10 wherein the conductive material is carbon black.

15. A method for improving a physical property of a composition produced by fused filament fabrication 3D printing using a filament including a base material and a polymer, the method comprising;
subjecting said composition to a solvent in conditions sufficient to degrade the polymer and thereby enhancing the physical properties of the base material.

16. A method for improving the conductivity of a composition produced by fused filament fabrication 3D printing using a filament including a weight % of a first conductive material and a weight % of a first polymer, the method comprising:
subjecting said composition to a solvent in conditions sufficient to degrade a weight % of the first polymer and thereby enhancing the weight % of the fist conductive material.

17. A method for improving the conductivity of a composition, comprising:
obtaining a filament including a conductive material and a first polymer wherein said first polymer is degradable by a first solvent;
printing the composition by fused filament fabrication 3D printing using said filament;
obtaining said first solvent;
subjecting the printed composition to said solvent in conditions sufficient to degrade said first polymer.

18. The method of claim 17 wherein said filament includes a second polymer wherein said second polymer is not degradable by said first solvent.

19. The method of claim 18 wherein the printed composition is subjected to said first solvent by soaking the printed composition in said first solvent in conditions sufficient to dissolve at least some of said first polymer.

20. The method of claim 18 wherein said first polymer is an acrylonitrile butadiene styrene composite and said first solvent is UV light and said method further includes exposing the printed composition to said UV light in conditions sufficient to degrade at least some of said first polymer.
